(19) United States
(12) Patent Application Publication
(10) Pub. No.: US 2023/0337880 A1
(43) Pub. Date: Oct. 26, 2023

(54) Method for Establishing Map Traversal Blocks of Global Grid Map, Chip, and Mobile Robot

(71) Applicant: AMICRO SEMICONDUCTOR CO.,LTD., Zhuhai, Guangdong (CN)

(72) Inventors: Ming LI, Zhuhai, Guangdong (CN); Qinwei LAI, Zhuhai, Guangdong (CN); Yongyong LI, Zhuhai, Guangdong (CN)

(21) Appl. No.: 17/791,916

(22) PCT Filed: Nov. 24, 2020
(86) PCT No.: PCT/CN2020/131197

§ 371 Date: Jul. 11, 2022

(30) Foreign Application Priority Data
May 26, 2020 (CN) 202010456789.7

(51) Int. Cl. A47L 11/40; G05D 1/02

(52) U.S. Cl. CPC A47L 11/4011; A47L 11/4002; G05D 1/0212; G05D 1/0274; A47L 2201/04; G05D 2201/0203

(57) ABSTRACT

A method for establishing map traversal blocks of a global grid map, a chip, and a mobile robot. The method for establishing the map traversal blocks includes: step 1, setting side lengths of the map traversal blocks according to a size of the global grid map; step 2, calculating a coverage number of map traversal blocks in each of a global coordinate axis direction of the global grid map in combination with a ratio relationship between the size of the global grid map and the side lengths of the map traversal blocks determined in step 1; step 3, according to a constraint effect of the coverage number of the map traversal blocks determined in step 2, performing a row-by-row and column-by-column accumulated operation on the side lengths of the map traversal blocks determined in step 1 to calculate mapping coordinates of each of a map traversal block.

### CROSS-REFERENCE TO RELATED APPLICATION

The present disclosure is a national stage filing of PCT Application No. PCT/CN2020/131197 filed on Nov. 24, 2020, which claims priority to Chinese patent application No. 202010456789.7, filed on May 26, 2020, and entitled “Method for Establishing Map Traversal Blocks of Global Grid Map, Chip, and Mobile Robot”, the contents of which are hereby incorporated by reference in its entirety.

### TECHNICAL FIELD

The disclosure relates to the technical field of map region division, and in particular to a method for establishing map traversal blocks of a global grid map, a chip, and a mobile robot.

### BACKGROUND ART

A prerequisite for a cleaning robot to perform cleaning tasks efficiently is to have a map describing the surrounding environment. In the aspect of establishment of the environment map, the robot can acquire environment information by adopting modes such as boundary learning through a sensor and combining the existing Simultaneous Localization and Mapping (SLAM) technology, and a grid map describing environment characteristics is established on this basis. After the map is established, the sweeping robot can perform cleaning work.

With the improvement of the requirement of people on the working efficiency of the cleaning robot, especially in some large-scale indoor global environments, the grid information quantity required to be collected by the sweeping robot is greatly increased, so that software resources for constructing and using the grid map are increased, and the efficiency of the robot for navigating by using the global grid map is reduced.

### SUMMARY

A method for establishing map traversal blocks of a global grid map includes: S1, side lengths of the map traversal blocks are set according to a size of the global grid map, so as to enable the map traversal blocks to occupy a sufficiently large grid region in the global grid map; S2, a coverage number of map traversal blocks in each of a global coordinate axis direction of the global grid map is calculated in combination with a ratio relationship between the size of the global grid map and the side lengths of the map traversal blocks determined in S1; and S3, according to a constraint effect of the coverage number of the map traversal blocks determined in S2, a row-by-row and column-by-column accumulated operation is carried out on the side lengths of the map traversal blocks determined in S1 to calculate mapping coordinates of each of a map traversal block, so as to enable the map traversal blocks to be established in each row and each column of the global grid map, and each of the map traversal block is formed by combining corresponding grids according to the mapping coordinates and the side length of the map traversal block.

Optionally, map traversal blocks of each row of the global grid map are arranged in a horizontal coordinate axis direction and projections of the map traversal blocks in a vertical coordinate axis direction are overlapped, and map traversal blocks of each column of the global grid map are arranged in the vertical coordinate axis direction and projections of the map traversal blocks in the horizontal coordinate axis direction are overlapped; and the global coordinate axis directions include the vertical coordinate axis direction and the horizontal coordinate axis direction. In the disclosure, the grids on the global map are combined row by row and column by column and subjected to block processing to form regularly distributed map traversal blocks.

Optionally, S1 specifically includes: S11, a standard side length is preset; S12, whether a length and a width of the global grid map are both greater than 2 times of the standard side length or not is judged, in a case that the length and the width of the global grid map are both greater than 2 times of the standard side length, the side length of the map traversal block is set as the standard side length, otherwise, the process proceeds to S13; S13, whether the length and the width of the global grid map are both greater than the standard side length or not is judged, in a case that the length and the width of the global grid map are both greater than the standard side length, the side length of the map traversal block is set to be half of the standard side length, otherwise, the process proceeds to S14; and S14, the side length of the map traversal block is set to be one fourth of the standard side length, and the global grid map is a rectangular map region.

Optionally, S2 specifically includes: a ratio of an effective length of the global grid map to the side lengths of the map traversal blocks is calculated, and plus-one processing is carried out to obtain a coverage number of the map traversal blocks in the vertical coordinate axis direction of the global grid map; and a ratio of an effective width of the global grid map to the side lengths of the map traversal blocks is calculated, and plus-one processing is carried out to obtain a coverage number of the map traversal blocks in the horizontal coordinate axis direction of the global grid map. Therefore, the map traversal blocks of the coverage number can completely mark the environment information of the global working region.

Optionally, S3 specifically includes: S31, by taking a grid position at a lower left corner of the global grid map as a reference original point, the process proceeds to S32; S32, starting from the reference original point, a coordinate of the reference original point on the vertical coordinate axis plus the side length of the map traversal block to calculate and determine a mapping coordinate of a currently determined map traversal block on the vertical coordinate axis, meanwhile, it is determined that a mapping coordinate of a currently determined map traversal block on the horizontal coordinate axis is equal to a coordinate of the reference original point on the horizontal coordinate axis, then the process proceeds to S33, and the reference original point is a position with a minimum coordinate value on each of the global coordinate axis of the global grid map; S33, whether a number of the map traversal blocks of which the mapping coordinates have been determined in the vertical coordinate axis direction is smaller than the coverage number of the map traversal blocks in the vertical coordinate axis direction of the global grid map or not is judged, in a case that the mapping coordinates have been determined in the vertical coordinate axis direction is smaller than the coverage number of the map traversal blocks in the vertical coordinate axis direction of the global grid map, the process proceeds to S34, otherwise, the process proceeds to S35; S34, the mapping coordinate of the currently determined map traversal block on the vertical coordinate axis plus the side length of the map traversal block to calculate and determine a mapping coordinate of an adjacent map traversal block in the same vertical coordinate axis direction on the vertical coordinate axis, meanwhile, it is determined that a mapping coordinate of the adjacent map traversal block in the same vertical coordinate axis direction on the horizontal coordinate axis is the same as the mapping coordinate of the currently determined map traversal block on the horizontal coordinate axis, then the process returns to S33, so that mapping coordinates of each of the map traversal block in the same vertical coordinate axis direction are determined row by row under a constraint effect of a coverage number in the same vertical coordinate axis direction; S35, the mapping coordinate of the currently determined map traversal block on the horizontal coordinate axis plus the side length of the map traversal block to calculate and determine a mapping coordinate of the adjacent map traversal block in the same horizontal coordinate axis direction on the horizontal coordinate axis, meanwhile, it is determined that a mapping coordinate of the adjacent map traversal block in the same horizontal coordinate axis direction on the vertical coordinate axis is the same as the mapping coordinate of the currently determined map traversal block on the vertical coordinate axis, then the process proceeds to S36, and mapping coordinates of each of the map traversal block in the same horizontal coordinate axis direction are determined column by column under a constraint effect of a coverage number in the same horizontal coordinate axis direction; S36, whether a number of the map traversal blocks of which the mapping coordinates have been determined in the horizontal coordinate axis direction is smaller than the coverage number of the map traversal blocks in the horizontal coordinate axis direction of the global grid map or not is judged, in a case that the number of the map traversal blocks of which the mapping coordinates have been determined in the horizontal coordinate axis direction is smaller than the coverage number of the map traversal blocks in the horizontal coordinate axis direction of the global grid map, the process returns to S33, otherwise, it is determined that the mapping coordinates of each of the map traversal block in the global grid map have been calculated row by row and column by column, so that the map traversal blocks are established in each row and each column of the global grid map, and a block processing of the global grid map is completed.

Optionally, S3 specifically includes: S31, by taking the grid position at the lower left corner of the global grid map as a reference original point, the process proceeds to S32; S32, starting from the reference original point, a coordinate of the original point on the vertical coordinate axis plus the side length of the map traversal blocks to calculate and determine the mapping coordinate of the adjacent map traversal block in the same horizontal coordinate axis direction on the horizontal coordinate axis, meanwhile, it is determined that the mapping coordinate of the currently determined map traversal block on the vertical coordinate axis is equal to the coordinate of the reference original point on the vertical coordinate axis, then the process proceeds to S33, and the reference original point is the position with the minimum coordinate value on each of the global coordinate axis of the global grid map; S33, whether the number of the map traversal blocks of which the mapping coordinates have been determined in the horizontal coordinate axis direction is smaller than the coverage number of the map traversal blocks in the horizontal coordinate axis direction of the global grid map or not is judged, in a case that the number of the map traversal blocks of which the mapping coordinates have been determined in the horizontal coordinate axis direction is smaller than the coverage number of the map traversal blocks in the horizontal coordinate axis direction of the global grid map, the process proceeds to S34, otherwise, the process proceeds to S35; S34, the mapping coordinate of the currently determined map traversal block on the horizontal coordinate axis plus the side length of the map traversal block to calculate and determine the mapping coordinate of the adjacent map traversal block in the same horizontal coordinate axis direction on the horizontal coordinate axis, meanwhile, it is determined that the mapping coordinate of the adjacent map traversal block in the same horizontal coordinate axis direction on the vertical coordinate axis is the same as the mapping coordinate of the currently determined map traversal block on the vertical coordinate axis, then the process returns to S33, so that the mapping coordinates of each of the map traversal block in the same horizontal coordinate axis direction are determined column by column under the constraint effect of the coverage number in the same horizontal coordinate axis direction; S35, the mapping coordinate of the currently determined map traversal block on the vertical coordinate axis plus the side length of the map traversal block to calculate and determine the mapping coordinate of the adjacent map traversal block in the same vertical coordinate axis direction on the vertical coordinate axis, meanwhile, it is determined that the mapping coordinate of the adjacent map traversal block in the same vertical coordinate axis direction on the horizontal coordinate axis is the same as the mapping coordinate of the currently determined map traversal block on the horizontal coordinate axis, and then the process proceeds to step 36, so that the mapping coordinates of each of the map traversal block in the same vertical coordinate axis direction are determined row by row under the constraint effect of the coverage number in the same vertical coordinate axis direction; S36, whether the number of the map traversal blocks of which the mapping coordinates have been determined in the vertical coordinate axis direction is smaller than the coverage number of the map traversal blocks in the vertical coordinate axis direction of the global grid map or not is judged, in a case that the number of the map traversal blocks of which the mapping coordinates have been determined in the vertical coordinate axis direction is smaller than the coverage number of the map traversal blocks in the vertical coordinate axis direction of the global grid map, the process returns to S33, otherwise, it is determined that the mapping coordinates of each of the map traversal block in the global grid map have been calculated row by row and column by column, so that the map traversal blocks are established in each row and each column of the global grid map, and the block processing of the global grid map is completed. The technical effects of the technical solution are the same as those of the abovementioned technical solution.

Optionally, a coordinate of a grid point traversed by a robot in the vertical coordinate axis direction is greater than or equal to the mapping coordinate of the map traversal block in the vertical coordinate axis direction, the coordinate of the grid point traversed by the robot in the vertical coordinate axis direction is smaller than or equal to a result obtained by subtracting one from the sum of the mapping coordinate of the map traversal block in the vertical coordinate axis direction and the side length of the map traversal block, a coordinate of the grid point traversed by the robot in the horizontal coordinate axis direction is greater than or equal to the mapping coordinate of the map traversal block in the horizontal coordinate axis direction, the coordinate of the grid point traversed by the robot on the horizontal coordinate axis direction is smaller than or equal to a result obtained by subtracting one from the sum of the mapping coordinate of the map traversal block in the horizontal coordinate axis direction and the side length of the map traversal block, it is determined that the grid point traversed by the robot is located in the map traversal block, so that when a cleaning robot traverses any grid in the map traversal block, a corresponding map traversal block is marked as a traversed map traversal block. According to the technical solution, the left boundary of the map traversal block is defined to be contained in its inner region, the right boundary of the map traversal block is defined to be included in an inner region of an adjacent map traversal block in the horizontal coordinate axis direction, the lower boundary of the map traversal block is defined to be included in its inner region, and the upper boundary of the map traversal block is defined to be included in the inner region of the adjacent map traversal block in the vertical coordinate axis direction.

A chip, having a built-in control program for dividing a global grid map constructed by a mobile robot in real time by executing the method for establishing the map traversal blocks. A mobile robot, having the built-in chip.

### BRIEF DESCRIPTION OF THE DRAWINGS

FIG. 1 is a flowchart of a method for establishing map traversal blocks of a global grid map according to an embodiment of the disclosure.

FIG. 2 is a flowchart of a method for setting side lengths of map traversal blocks according to an embodiment of the disclosure.

FIG. 3 is a flowchart of a method for calculating mapping coordinates of map traversal blocks according to an embodiment of the disclosure.

### DETAILED DECEPTION OF THE EMBODIMENTS

The technical solutions in the embodiments of the disclosure will be described in detail below with reference to the drawings in the embodiments of the disclosure. The accompanying drawings are provided for further illustrating the embodiments. The accompanying drawings, which are incorporated in and constitute a part of the disclosure, mainly illustrate the embodiments, together with the description of the specification, serve to explain the principles of the embodiments. With these references, those of ordinary skill in the art will appreciate other possible implementation modes and advantages of the disclosure. The components in the figures are not drawn to scale, and similar reference numerals are generally used to denote similar components.

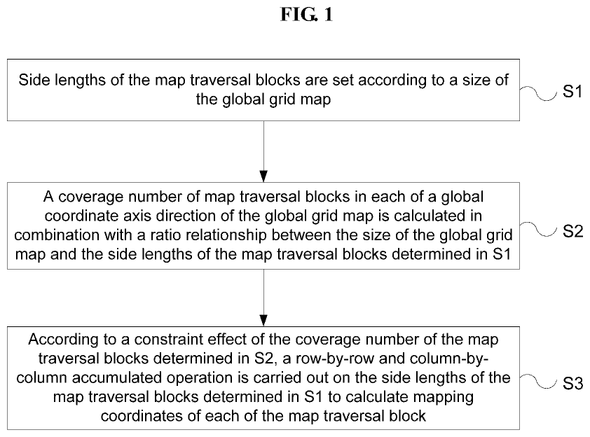

The embodiments of the disclosure disclose a method for establishing map traversal blocks of a global grid map, which can be executed before a cleaning robot carries out cleaning traversal on a global working region in a preset cleaning mode, so that the mobile robot can clean the global working region after block processing. As shown in FIG. 1, the method for establishing the map traversal blocks of the global grid map includes: S1, side lengths of the map traversal blocks are set according to a size (including a length and a width of the map) of the global grid map, so as to enable the map traversal blocks to occupy a grid region with a certain coverage range in the global grid map, and the grid region range is set by those skilled in art depending on the size of the cleaning robot and the working region in which it is located; S2, a coverage number of map traversal blocks in each of a global coordinate axis direction (including an X axis direction and a Y axis direction of the global coordinate system) of the global grid map is calculated in combination with a ratio relationship between the size of the global grid map and the side lengths of the map traversal blocks determined in S1, and the map traversal blocks are equivalent to sub-regions divided by the global grid map; S3, according to a constraint effect of the coverage number of the map traversal blocks determined in S2, a row-by-row and column-by-column accumulated operation is carried out on the side lengths of the map traversal blocks determined in S1 to calculate mapping coordinates of each of the map traversal block, so as to enable the map traversal blocks to be established in each row and each column of the global grid map, namely, the coverage number of the map traversal blocks can determine the boundary information of the global grid map, the distribution number and positions of the map traversal blocks in each row and each column of the global grid map are constrained, and each of the map traversal block is formed by combining corresponding grids according to the mapping coordinates and the side length of the map traversal block. The grids of each row and each column of the map are combined to establish the map traversal blocks with a certain size and quantity, each of the map traversal block corresponds to a small region occupied in an actual environment, and a general path of the robot can be planned as long as the size of the grids is set to be slightly larger, so that the calculation amount is reduced, and the robot can easily process map information. With the method for establishing the map traversal blocks of the global grid map, the large-scale global grid map is divided into a plurality of map sub-regions, therefore, the requirements on navigation localization computing power of the mobile robot and the requirements on the map data storage space are reduced, the operation resources of the grid surface in the global map are saved, and the data processing speed is accelerated. The method can be applied to the coverage rate and region area calculation of path planning, boundary walking and recharging path planning.

It is to be noted that map traversal blocks of each row of the global grid map are arranged in a horizontal coordinate axis direction and projections of the map traversal blocks in a vertical coordinate axis direction are overlapped, and map traversal blocks of each column of the global grid map are arranged in the vertical coordinate axis direction and projections of the map traversal blocks in the horizontal coordinate axis direction are overlapped; and the global coordinate axis directions include the vertical coordinate axis direction and the horizontal coordinate axis direction. In the disclosure, the grids on the global map are combined row by row and column by column to establish regularly distributed map traversal blocks. It is equivalent that the global map is divided into small map blocks.

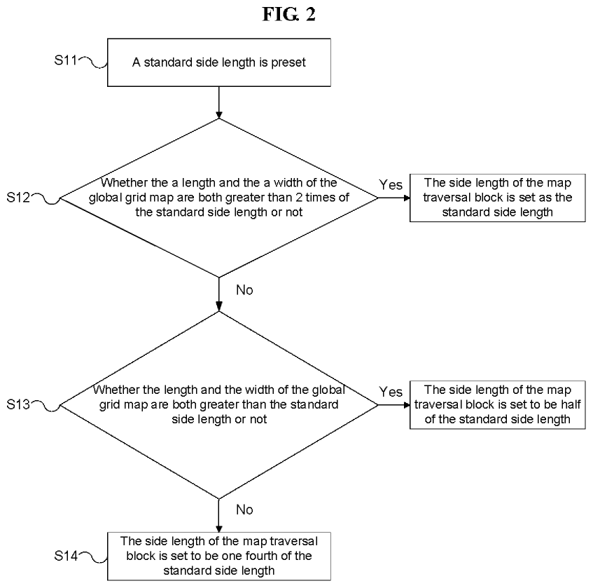

In the embodiment, as shown in the flowchart of the method for setting the side lengths of the map traversal blocks disclosed in FIG. 2, S1 specifically includes: S11, a standard side length E is preset, which can be set to a maximum value of 16, so that each of the map traversal block fill a maximum of 16×16 grids, and then the process proceeds to S12. In the embodiment, the global grid map corresponding to the global working region is a rectangular map, and the map traversal blocks filling and covering the global grid map are squares. S12, whether the length and the width of the global grid map are both greater than 2 times of the standard side length or not is judged, in a case that the length and the width of the global grid map are both greater than 2 times of the standard side length, the side length of the map traversal blocks is set as the standard side length, otherwise, the process proceeds to S13; S13, whether the length and the width of the global grid map are both greater than the standard side length or not is judged, in a case that the length and the width of the global grid map are both greater than the standard side length, the side length of the map traversal blocks is set to be half of the standard side length, otherwise, the process proceeds to S14; and S14, the side length of the map traversal blocks is set to be one fourth of the standard side length. Compared with the relevant art, a grid expansion processing of the global grid map is realized by the map traversal block formed by every 16×16 map grids, therefore, the map traversal blocks occupy a sufficiently large grid region in the global grid map, and the robot can traverse and mark map path information in the adaptation range. Therefore, the size of the grids is set to be slightly larger, only a general path of the robot needs to be planned, the calculation amount is reduced, and the method is suitable for path planning, boundary walking and recharging path planning.

In the embodiment, a ratio of an effective length of the global grid map to the side length of the map traversal blocks is calculated, and plus-one processing is carried out to obtain a coverage number of the map traversal blocks established in the vertical coordinate axis direction of the global grid map; and a ratio of an effective width of the global grid map to the side length of the map traversal blocks is calculated, and plus-one processing is carried out to obtain a coverage number of the map traversal blocks in the horizontal coordinate axis direction of the global grid map. The necessity of plus-one processing here is that a software system rounds the ratio of the effective length of the global grid map to the side length of the map traversal blocks, and ignores the decimal part, so that plus-one processing is needed to ensure that the map traversal blocks with the coverage number completely record the actually covered global working region, and the redundancy of the spatial region is improved.

On the basis that the side lengths of the map traversal blocks are determined according to the above-mentioned method, the number of the map traversal blocks in each of the global coordinate axis direction of the global grid map is determined through calculation, specifically including that: the number H of the map traversal blocks in the vertical coordinate axis direction (namely in the length direction) of the global grid map=the ratio of the effective length of the global grid map to the side lengths of the map traversal blocks+1, and the number W of the map traversal blocks in the horizontal coordinate axis direction (namely in the width direction) of the global grid map=the ratio of the effective width of the global grid map to the side lengths of the map traversal blocks+1. The effective length and effective width in the embodiment include a grid region for the robot to traverse for constructing the map traversal blocks.

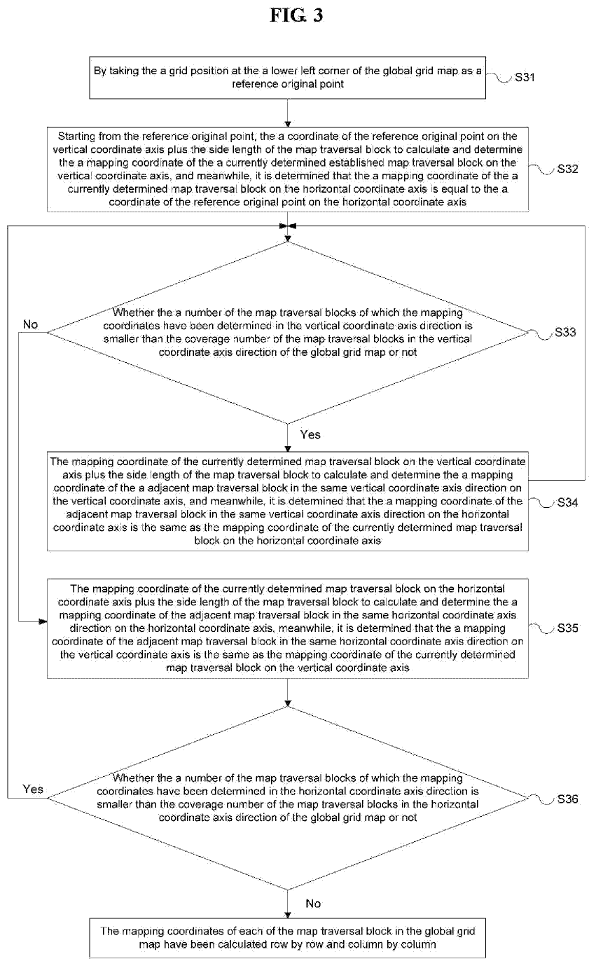

In the embodiment, as shown in the flowchart of the method for calculating mapping coordinates of the map traversal block disclosed by FIG. 3, S3 specifically includes: S31, by taking a grid position at a lower left corner of the global grid map as a reference original point, the process proceeds to S32; and by taking the lower left corner of the global grid map as a reference original point, the mapping coordinates of the map traversal blocks are calculated. Assuming that minx and miny are the coordinates of the reference original point of the global grid map respectively, and are also equivalent to a minimum coordinate value on an X axis of the global grid map and a minimum coordinate value on a Y axis of the global grid map respectively; i is set as the offset of the map traversal block relative to the reference original point in the X-axis direction, and i+1 is equivalent to the number of the map traversal blocks of which the mapping coordinates have been determined in the horizontal coordinate axis direction; j is set as the offset of the map traversal block relative to the reference original point in the Y-axis direction, and j+1 is equivalent to the number of the map traversal blocks of which the mapping coordinates have determined in the vertical coordinate axis direction; e is the side length of the map traversal block; X (i, j) is the mapping coordinate of the map traversal block in the horizontal coordinate axis direction of the global grid map, and Y (i, j) is the mapping coordinate of the map traversal block in the vertical coordinate axis direction of the global grid map. S32, starting from the coordinates of the reference original point (minx, miny), a coordinate of the reference original point on the vertical coordinate axis plus the side length of the map traversal blocks to calculate and determine a mapping coordinate of a currently determined map traversal block on the vertical coordinate axis, namely when j=0, the minimum mapping coordinate Y (i, j)=j*e+miny=miny on the vertical coordinate axis is obtained, meanwhile, it is determined that a mapping coordinate of a currently determined map traversal block on the horizontal coordinate axis is equal to a coordinate minx of the reference original point on the horizontal coordinate axis, and then the process proceeds to S33. S33, whether the number j of the map traversal blocks of which the mapping coordinates have been determined in the vertical coordinate axis direction is smaller than the coverage number H of the map traversal blocks in the vertical coordinate axis direction of the global grid map or not is judged, in a case that the number j is smaller than the coverage number H, the process proceeds to S34, otherwise, the process proceeds to S35. S34, the mapping coordinate of the currently determined map traversal block on the vertical coordinate axis plus the side length of the map traversal block to calculate and determine a mapping coordinate of an adjacent map traversal block in the same vertical coordinate axis direction on the vertical coordinate axis, namely Y (i, j+1)=(j+1)*e+miny, then the adjacent Y-axis mapping coordinate in the same vertical coordinate axis direction is formed, and j automatically plus one each time the process proceeds to S34; meanwhile, it is determined that a mapping coordinate X (i, j+1) of the adjacent map traversal block in the same vertical coordinate axis direction on the horizontal coordinate axis is the same as the mapping coordinate X (i, j) of the currently determined map traversal block on the horizontal coordinate axis, and then the process returns to the S33, so that mapping coordinates of each of the map traversal block in the same vertical coordinate axis direction are determined row by row under a constraint effect of a coverage number in the same vertical coordinate axis direction. S35, the mapping coordinate of the currently determined map traversal block on the horizontal vertical coordinate axis plus the side length of the map traversal block to calculate and determine a mapping coordinate of the adjacent map traversal block in the same horizontal coordinate axis direction on the horizontal coordinate axis, namely when i=0, the minimum mapping coordinate X (i, j)=i*e+minx=minx on the horizontal coordinate axis is obtained, and i automatically plus one each time the process proceeds to S35; meanwhile, it is determined that a mapping coordinate Y (i+1, j) of the adjacent map traversal block in the same horizontal coordinate axis direction on the vertical coordinate axis is the same as the mapping coordinate Y (i, j) of the currently determined map traversal block on the vertical coordinate axis, and then the process proceeds to S36, so that mapping coordinates of each of the map traversal block in the same horizontal coordinate axis direction are determined column by column under a constraint effect of a coverage number in the same horizontal coordinate axis direction. S36, whether a number i of the map traversal blocks of which the mapping coordinates have been determined in the horizontal coordinate axis direction is smaller than the coverage number W of the map traversal blocks in the horizontal coordinate axis direction of the global grid map or not is judged, in a case that the number of i is smaller than the coverage number W, the process returns to S33, otherwise, it is determined that the mapping coordinates of each of the map traversal block in the global grid map have been calculated row by row and column by column, so that the map traversal blocks are established in each row and each column of the global grid map, and a block processing of the global grid map is completed. Therefore, the minimum mapping coordinate X (i, j)=i*e+minx of the map traversal block in the X-axis direction and the minimum mapping coordinate Y (i, j)=j*e+miny of the map traversal block in the Y-axis direction can be calculated according to the offset relative to the reference original point in the X-axis direction and the Y-axis direction and the side length of the map traversal block, therefore, the grid coordinate range of the map traversal block in the X-axis direction and the Y-axis direction of the global grid map is determined, namely, the grid coordinate range of the map traversal block in the X-axis direction is greater than or equal to X (i, j), but smaller than or equal to X (i, j)+e−1; the grid coordinate range of the map traversal block in the Y-axis direction is greater than or equal to Y (i, j) but smaller than or equal to Y (i, j)+e−1; and according to the number of the map traversal blocks in each of the global coordinate axis direction of the global grid map and the grid coordinate range where the map traversal blocks are located, the map traversal blocks are distributed to each row and each column of the global grid map. According to the abovementioned technical solution, according to the map boundary constraint effect achieved by the coverage number of the map traversal blocks determined in the previous step, row-by-row and column-by-column accumulated operation is carried out on the side lengths of the determined map traversal blocks, including the current column is traversed first and then the next column is traversed until all columns of map traversal blocks distributed in the horizontal coordinate axis direction are traversed, so that the mapping coordinates of each of the map traversal block are determined, the map traversal blocks are established on the regular region blocks of each row and each column of the global grid map, and the global grid map is divided into the map traversal blocks.

In another embodiment, S3 can further include: S31, by taking the grid position at the lower left corner of the global grid map as a reference original point, the process proceeds to S32; S32, starting from the reference original point, a coordinate of the reference original point on the horizontal coordinate axis plus the side length of the map traversal block to calculate and determine the mapping coordinate of the adjacent map traversal block in the same horizontal coordinate axis direction on the horizontal coordinate axis, meanwhile, it is determined that the mapping coordinate of the currently determined map traversal block on the vertical coordinate axis is equal to the coordinate of the reference original point on the vertical coordinate axis, then the process proceeds to S33, and the reference original point is the position with the minimum coordinate value on each of the global coordinate axis of the global grid map; S33, whether the number of the map traversal blocks of which the mapping coordinates have been determined in the horizontal coordinate axis direction is smaller than the coverage number of the map traversal blocks in the horizontal coordinate axis direction of the global grid map or not is judged, in a case that the number of the map traversal blocks of which the mapping coordinates have been determined in the horizontal coordinate axis direction is smaller than the coverage number of the map traversal blocks in the horizontal coordinate axis direction of the global grid map, the process proceeds to S34, otherwise, the process proceeds to S35; S34, the mapping coordinate of the currently determined map traversal block on the horizontal coordinate axis plus the side length of the map traversal block to calculate and determine the mapping coordinate of the adjacent map traversal block in the same horizontal coordinate axis direction on the horizontal coordinate axis, meanwhile, it is determined that the mapping coordinate of the adjacent map traversal block in the same horizontal coordinate axis direction on the vertical coordinate axis is the same as the mapping coordinate of the currently determined map traversal block on the vertical coordinate axis, then the process enters S33, so that the mapping coordinates of each of the map traversal block in the same horizontal coordinate axis direction are determined column by column under the constraint effect of the coverage number in the same horizontal coordinate axis direction; S35, the mapping coordinate of the currently determined map traversal block on the vertical coordinate axis plus the side length of the map traversal block to calculate and determine the mapping coordinate of the adjacent map traversal block in the same vertical coordinate axis direction on the vertical coordinate axis, meanwhile, it is determined that the mapping coordinate of the adjacent map traversal block in the same vertical coordinate axis direction on the horizontal coordinate axis is the same as the mapping coordinate of the currently determined map traversal block on the horizontal coordinate axis, then the process proceeds to S36, and the mapping coordinates of each of the map traversal block in the same vertical coordinate axis direction are determined row by row under the constraint effect of the coverage number in the same vertical coordinate axis direction; S36, whether the number of the map traversal blocks of which the mapping coordinates have been determined in the vertical coordinate axis direction is smaller than the coverage number of the map traversal blocks in the vertical coordinate axis direction of the global grid map or not is judged, in a case that the number of the map traversal blocks of which the mapping coordinates have been determined in the vertical coordinate axis direction is smaller than the coverage number of the map traversal blocks in the vertical coordinate axis direction of the global grid map, the process returns to S33, otherwise, it is determined that the mapping coordinates of each of the map traversal block in the global grid map have been calculated row by row and column by column, so that the map traversal blocks are established in each row and each column of the global grid map, and block processing of the global grid map is completed. Compared with the previous embodiment, in the embodiment, the current row is traversed first and then the next row is traversed until all rows of map traversal blocks distributed in the vertical coordinate axis direction are traversed, and the involved coordinate value accumulation step is similar to that of the previous embodiment, so that no detailed elaboration will be made herein.

In another embodiment, a coordinate of a grid point traversed by a robot on the vertical coordinate axis is greater than or equal to the mapping coordinate of the map traversal block on the vertical coordinate axis; the coordinate of the grid point traversed by the robot on the vertical coordinate axis is smaller than or equal to a result obtained by subtracting one from the sum of the mapping coordinate of the map traversal block on the vertical coordinate axis and the side length of the map traversal block; a coordinate of the grid point traversed by the robot on the horizontal coordinate axis is greater than or equal to the mapping coordinate of the map traversal block on the horizontal coordinate axis; the coordinate of the grid point traversed by the robot on the horizontal coordinate axis is smaller than or equal to a result obtained by subtracting one from the sum of the mapping coordinate of the map traversal block on the horizontal coordinate axis and the side length of the map traversal block, and it is determined that the grid point traversed by the robot is located in the map traversal block. Therefore, the method for judging whether a grid position coordinate (a, b) of the global grid map belongs to a traversal map block or not includes: whether a is greater than or equal to X (i, j) and smaller than or equal to X (i, j)+e−1 is judged; meanwhile, whether b is greater than or equal to Y (i, j) and smaller than or equal to Y (i, j)+e−1 or not is judged; and when the grid position coordinate (a, b) meets the two judgment conditions at the same time, it is determined that the grid position coordinate (a, b) is located in the map traversal block. When a cleaning robot traverses any grid in the map traversal block, a corresponding map traversal block is marked as a traversed map traversal block, in the embodiment, the left boundary of the map traversal block is defined to be contained in its inner region, the right boundary of the map traversal block is defined to be contained in the inner region of the adjacent map traversal block in the horizontal coordinate axis direction, so that the region between the left boundary and the right boundary of the map traversal block and the left boundary of the map traversal block belong to the same map traversal block, grids contained inside belong to the grids forming the map traversal block, meanwhile, the lower boundary of the map traversal block is defined to be contained in its inner region, the upper boundary of the map traversal block is defined to be contained in the inner region of the adjacent map traversal block in the vertical coordinate axis direction, the region between the lower boundary and the upper boundary of the map traversal block and the lower boundary of the map traversal block belong to the same map traversal block, and the grids contained inside belong to the grids forming the map traversal block.

When the cleaning robot traverses any grid in the map traversal block according to the preset cleaning mode, for example, when the cleaning robot traverses the grid position coordinate (a, b), the corresponding map traversal block is marked as the traversed map traversal block; a cleaning path traversed by the cleaning robot in a global working region is composed of the traversed map traversal blocks, and compared with a mode of grid marking one by one, the map traversal blocks record a larger path region range, the number of marking blocks used for marking the same path is reduced, the requirements on the computing power of the cleaning robot and the requirements on the storage space are reduced, and the map constructing time is reduced.

A chip, having a built-in control program for dividing a global grid map constructed by a mobile robot in real time by executing the method for establishing the map traversal blocks. It is to be understood that the embodiments described herein can be implemented by hardware, software, firmware, middleware, microcode, or any combination thereof. For a hardware implementation mode, a processing unit can be implemented within one or more of an Application Specific Integrated Circuit (ASIC), a Digital Signal Processor (DSP), a Digital Signal Processing Device (DSPD), a Programmable Logic Device (PLD), a Field Programmable Gate Array (FPGA), a processor, a controller, a micro-controller, a microprocessor, other electronic units designed to perform the functions described herein, or a combination thereof. When the embodiments are implemented in software, firmware, middleware or microcode, program code or code segments, they can be stored in a machine-readable medium, such as a storage component.

A mobile robot, having the built-in chip.

The logic and/or steps represented in the flowcharts or otherwise described herein, such as an ordered listing of executable instructions that can be considered to implement logical functions, can be embodied in any computer-readable medium for use by or in connection with an instruction execution system, apparatus, or device, (such as a computer-based system, processor-containing system, or other system that can fetch the instructions from the instruction execution system, apparatus, or device and execute the instructions). For the purposes of this description, the “computer-readable medium” can be any apparatus that can contain, store, communicate, propagate, or transport the program for use by or in connection with the instruction execution system, apparatus, or device. More specific examples (a non-exhaustive list) of the computer-readable medium include the following: an electrical connection (electronic device) having one or more wires, a portable computer diskette (magnetic device), a Random Access Memory (RAM), a Read-Only Memory (ROM), an Erasable Programmable Read-Only Memory (EPROM or flash memory), an optical fiber device, and a portable Compact Disc Read-Only Memory (CDROM). In addition, the computer-readable medium can even be paper or another suitable medium upon which the program can be printed, as the program can be electronically captured, via for instance optical scanning of the paper or other medium, then compiling, interpreting or otherwise processing in a suitable manner if necessary, and then is stored in a computer memory.

The above embodiments are only for illustrating the technical idea and features of the disclosure, and the purpose is to enable those skilled in the art to understand the content of the disclosure and implement the disclosure accordingly, and not to limit the protection scope of the disclosure accordingly. All equivalent changes and modifications made according to the spirit of the disclosure should be covered in the protection scope of the disclosure.

1. A method for establishing map traversal blocks of a global grid map, comprising:
S1, setting side lengths of the map traversal blocks according to a size of the global grid map;
S2, calculating a coverage number of map traversal blocks in each of a global coordinate axis direction of the global grid map in combination with a ratio relationship between the size of the global grid map and the side lengths of the map traversal blocks determined in S1;
S3, according to a constraint effect of the coverage number of the map traversal blocks determined in S2, carrying out a row-by-row and column-by-column accumulated operation on the side lengths of the map traversal blocks determined in S1 to calculate mapping coordinates of each of a map traversal block, so as to enable the map traversal blocks to be established in each row and each column of the global grid map;
wherein each of the map traversal block is formed by combining corresponding grids according to its mapping coordinates and side length.

2. The method for establishing the map traversal blocks according to claim 1, wherein map traversal blocks of each row of the global grid map are arranged in a horizontal coordinate axis direction and projections of the map traversal blocks in a vertical coordinate axis direction are overlapped, and map traversal blocks of each column of the global grid map are arranged in the vertical coordinate axis direction and projections of the map traversal blocks in the horizontal coordinate axis direction are overlapped;
the global coordinate axis directions comprise the vertical coordinate axis direction and the horizontal coordinate axis direction.

3. The method for establishing the map traversal blocks according to claim 2, wherein S1 specifically comprises:
S11, presetting a standard side length, and then entering S12;
S12, judging whether a length and a width of the global grid map are both greater than 2 times of the standard side length or not, in a case that the length and the width of the global grid map are both greater than 2 times of the standard side length, setting the side length of the map traversal blocks as the standard side length, otherwise, entering S13;
S13, judging whether the length and the width of the global grid map are both greater than the standard side length or not, in a case that the length and the width of the global grid map are both greater than the standard side length, setting the side length of the map traversal blocks to be half of the standard side length, otherwise, entering S14;
S14, setting the side length of the map traversal blocks to be one fourth of the standard side length;
wherein the global grid map is a rectangular map region, and the map traversal blocks are squares.

4. The method for establishing the map traversal blocks according to claim 3, wherein S2 specifically comprises:
calculating a ratio of an effective length of the global grid map to the side length of the map traversal blocks, and carrying out plus-one processing to obtain a coverage number of the map traversal blocks in the vertical coordinate axis direction of the global grid map; and calculating a ratio of an effective width of the global grid map to the side length of the map traversal blocks, and carrying out plus-one processing to obtain a coverage number of the map traversal blocks in the horizontal coordinate axis direction of the global grid map.

5. The method for establishing the map traversal blocks according to claim 4, wherein S3 specifically comprises:
S31, taking a grid position at a lower left corner of the global grid map as a reference original point, and then entering S32;
S32, starting from the reference original point, adding a coordinate of the reference original point on the vertical coordinate axis with the side length of the map traversal block to calculate and determine a mapping coordinate of a currently determined map traversal block on the vertical coordinate axis, meanwhile, determining that a mapping coordinate of a currently determined map traversal block on the horizontal coordinate axis is equal to a coordinate of the reference original point on the horizontal coordinate axis, and then entering S33, wherein the reference original point is a position with a minimum coordinate value on each of the global coordinate axis of the global grid map;
S33, judging whether a number of the map traversal blocks of which the mapping coordinates have been determined in the vertical coordinate axis direction is smaller than the coverage number of the map traversal blocks in the vertical coordinate axis direction of the global grid map or not, in a case that the mapping coordinates have been determined in the vertical coordinate axis direction is smaller than the coverage number of the map traversal blocks in the vertical coordinate axis direction of the global grid map, entering S34, otherwise, entering S35;
S34, adding the mapping coordinate of the currently determined map traversal block on the vertical coordinate axis with the side length of the map traversal block to calculate and determine a mapping coordinate of an adjacent map traversal block in the same vertical coordinate axis direction on the vertical coordinate axis, meanwhile, determining that a mapping coordinate of the adjacent map traversal block in the same vertical coordinate axis direction on the horizontal coordinate axis is the same as the mapping coordinate of the currently determined map traversal block on the horizontal coordinate axis, and then returning to S33, so that mapping coordinates of each of the map traversal block in the same vertical coordinate axis direction are determined row by row under a constraint effect of a coverage number in the same vertical coordinate axis direction;
S35, adding the mapping coordinate of the currently determined map traversal block on the horizontal coordinate axis with the side length of the map traversal block to calculate and determine a mapping coordinate of the adjacent map traversal block in the same horizontal coordinate axis direction on the horizontal coordinate axis, meanwhile, determining that a mapping coordinate of the adjacent map traversal block in the same horizontal coordinate axis direction on the vertical coordinate axis is the same as the mapping coordinate of the currently determined map traversal block on the vertical coordinate axis, and then entering S36, so that mapping coordinates of each of the map traversal block in the same horizontal coordinate axis direction are determined column by column under a constraint effect of a coverage number in the same horizontal coordinate axis direction;
S36, judging whether a number of the map traversal blocks of which the mapping coordinates have been determined in the horizontal coordinate axis direction is smaller than the coverage number of the map traversal blocks in the horizontal coordinate axis direction of the global grid map or not, in a case that the number of the map traversal blocks of which the mapping coordinates have been determined in the horizontal coordinate axis direction is smaller than the coverage number of the map traversal blocks in the horizontal coordinate axis direction of the global grid map, returning to S33, otherwise, determining that the mapping coordinates of each of the map traversal block in the global grid map have been calculated row by row and column by column, so that the map traversal blocks are established in each row and each column of the global grid map, and a block processing of the global grid map is completed.

6. The method for establishing the map traversal blocks according to claim 4, wherein S3 specifically comprises:
S31, taking the grid position at the lower left corner of the global grid map as a reference original point, and then entering S32;
S32, starting from the reference original point, adding a coordinate of the reference original point on the horizontal coordinate axis with the side length of the map traversal block to calculate and determine the mapping coordinate of the adjacent map traversal block in the same horizontal coordinate axis direction on the horizontal coordinate axis, meanwhile, determining that the mapping coordinate of the currently determined map traversal block on the vertical coordinate axis is equal to the coordinate of the reference original point on the vertical coordinate axis, and then entering S33, wherein the reference original point is the position with the minimum coordinate value on each of the global coordinate axis of the global grid map;
S33, judging whether the number of the map traversal blocks of which the mapping coordinates have been determined in the horizontal coordinate axis direction is smaller than the coverage number of the map traversal blocks in the horizontal coordinate axis direction of the global grid map or not, in a case that the number of the map traversal blocks of which the mapping coordinates have been determined in the horizontal coordinate axis direction is smaller than the coverage number of the map traversal blocks in the horizontal coordinate axis direction of the global grid map, entering S34, otherwise, entering S35;
S34, adding the mapping coordinate of the currently determined map traversal block on the horizontal coordinate axis with the side length of the map traversal block to calculate and determine the mapping coordinate of the adjacent map traversal block in the same horizontal coordinate axis direction on the horizontal coordinate axis, meanwhile, determining that the mapping coordinate of the adjacent map traversal block in the same horizontal coordinate axis direction on the vertical coordinate axis is the same as the mapping coordinate of the currently determined map traversal block on the vertical coordinate axis, and then entering S33, so that the mapping coordinates of each of the map traversal block in the same horizontal coordinate axis direction are determined column by column under the constraint effect of the coverage number in the same horizontal coordinate axis direction;
S35, adding the mapping coordinate of the currently determined map traversal block on the vertical coordinate axis with the side length of the map traversal block to calculate and determine the mapping coordinate of the adjacent map traversal block in the same vertical coordinate axis direction on the vertical coordinate axis, meanwhile, determining that the mapping coordinate of the adjacent map traversal block in the same vertical coordinate axis direction on the horizontal coordinate axis is the same as the mapping coordinate of the currently determined map traversal block on the horizontal coordinate axis, and then entering S36, so that the mapping coordinates of each of the map traversal block in the same vertical coordinate axis direction are determined row by row under the constraint effect of the coverage number in the same vertical coordinate axis direction;
S36, judging whether the number of the map traversal blocks of which the mapping coordinates have been determined in the vertical coordinate axis direction is smaller than the coverage number of the map traversal blocks in the vertical coordinate axis direction of the global grid map or not, in a case that the number of the map traversal blocks of which the mapping coordinates have been determined in the vertical coordinate axis direction is smaller than the coverage number of the map traversal blocks in the vertical coordinate axis direction of the global grid map, returning to S33, otherwise, determining that the mapping coordinates of each of the map traversal block in the global grid map have been calculated row by row and column by column, so that the map traversal blocks are established in each row and each column of the global grid map, and the block processing of the global grid map is completed.

7. The method for establishing the map traversal blocks according to claim 5, wherein a coordinate of a grid point traversed by a robot on the vertical coordinate axis is greater than or equal to the mapping coordinate of the map traversal block on the vertical coordinate axis; the coordinate of the grid point traversed by the robot on the vertical coordinate axis is smaller than or equal to a result obtained by subtracting one from the sum of the mapping coordinate of the map traversal block on the vertical coordinate axis and the side length of the map traversal block; a coordinate of the grid point traversed by the robot on the horizontal coordinate axis is greater than or equal to the mapping coordinate of the map traversal block on the horizontal coordinate axis; the coordinate of the grid point traversed by the robot on the horizontal coordinate axis is smaller than or equal to a result obtained by subtracting one from the sum of the mapping coordinate of the map traversal block on the horizontal coordinate axis and the side length of the map traversal block, and it is determined that the grid point traversed by the robot is located in the map traversal block.

8. The method for establishing the map traversal blocks according to claim 7, wherein when a cleaning robot traverses any grid in the map traversal block, a corresponding map traversal block is marked as a traversed map traversal block.

9. A chip, having a built-in control program, wherein the control program is configured to divide a global grid map constructed by a mobile robot in real time by executing a method for establishing the map traversal blocks of a global grid map, comprising:
S1, setting side lengths of the map traversal blocks according to a size of the global grid map;
S2, calculating a coverage number of map traversal blocks in each of a global coordinate axis direction of the global grid map in combination with a ratio relationship between the size of the global grid map and the side lengths of the map traversal blocks determined in S1;
S3, according to a constraint effect of the coverage number of the map traversal blocks determined in S2, carrying out a row-by-row and column-by-column accumulated operation on the side lengths of the map traversal blocks determined in S1 to calculate mapping coordinates of each of a map traversal block, so as to enable the map traversal blocks to be established in each row and each column of the global grid map;
wherein each of the map traversal block is formed by combining corresponding grids according to its mapping coordinates and side length.

10. A mobile robot, having the built-in chip according to claim 9.

11. The method for establishing the map traversal blocks according to claim 6, wherein a coordinate of a grid point traversed by a robot on the vertical coordinate axis is greater than or equal to the mapping coordinate of the map traversal block on the vertical coordinate axis; the coordinate of the grid point traversed by the robot on the vertical coordinate axis is smaller than or equal to a result obtained by subtracting one from the sum of the mapping coordinate of the map traversal block on the vertical coordinate axis and the side length of the map traversal block; a coordinate of the grid point traversed by the robot on the horizontal coordinate axis is greater than or equal to the mapping coordinate of the map traversal block on the horizontal coordinate axis; the coordinate of the grid point traversed by the robot on the horizontal coordinate axis is smaller than or equal to a result obtained by subtracting one from the sum of the mapping coordinate of the map traversal block on the horizontal coordinate axis and the side length of the map traversal block, and it is determined that the grid point traversed by the robot is located in the map traversal block.

12. The chip according to claim 9, wherein map traversal blocks of each row of the global grid map are arranged in a horizontal coordinate axis direction and projections of the map traversal blocks in a vertical coordinate axis direction are overlapped, and map traversal blocks of each column of the global grid map are arranged in the vertical coordinate axis direction and projections of the map traversal blocks in the horizontal coordinate axis direction are overlapped;
the global coordinate axis directions comprise the vertical coordinate axis direction and the horizontal coordinate axis direction.

13. The chip according to claim 12, wherein S1 specifically comprises:
S11, presetting a standard side length, and then entering S12;
S12, judging whether a length and a width of the global grid map are both greater than 2 times of the standard side length or not, in a case that the length and the width of the global grid map are both greater than 2 times of the standard side length, setting the side length of the map traversal blocks as the standard side length, otherwise, entering S13;
S13, judging whether the length and the width of the global grid map are both greater than the standard side length or not, in a case that the length and the width of the global grid map are both greater than the standard side length, setting the side length of the map traversal blocks to be half of the standard side length, otherwise, entering S14;
S14, setting the side length of the map traversal blocks to be one fourth of the standard side length;
wherein the global grid map is a rectangular map region, and the map traversal blocks are squares.

14. The chip according to claim 13, wherein S2 specifically comprises:
calculating a ratio of an effective length of the global grid map to the side length of the map traversal blocks, and carrying out plus-one processing to obtain a coverage number of the map traversal blocks in the vertical coordinate axis direction of the global grid map; and calculating a ratio of an effective width of the global grid map to the side length of the map traversal blocks, and carrying out plus-one processing to obtain a coverage number of the map traversal blocks in the horizontal coordinate axis direction of the global grid map.

15. The chip according to claim 14, wherein S3 specifically comprises:
S31, taking a grid position at a lower left corner of the global grid map as a reference original point, and then entering S32;
S32, starting from the reference original point, adding a coordinate of the reference original point on the vertical coordinate axis with the side length of the map traversal block to calculate and determine a mapping coordinate of a currently determined map traversal block on the vertical coordinate axis, meanwhile, determining that a mapping coordinate of a currently determined map traversal block on the horizontal coordinate axis is equal to a coordinate of the reference original point on the horizontal coordinate axis, and then entering S33, wherein the reference original point is a position with a minimum coordinate value on each of the global coordinate axis of the global grid map;
S33, judging whether a number of the map traversal blocks of which the mapping coordinates have been determined in the vertical coordinate axis direction is smaller than the coverage number of the map traversal blocks in the vertical coordinate axis direction of the global grid map or not, in a case that the mapping coordinates have been determined in the vertical coordinate axis direction is smaller than the coverage number of the map traversal blocks in the vertical coordinate axis direction of the global grid map, entering S34, otherwise, entering S35;
S34, adding the mapping coordinate of the currently determined map traversal block on the vertical coordinate axis with the side length of the map traversal block to calculate and determine a mapping coordinate of an adjacent map traversal block in the same vertical coordinate axis direction on the vertical coordinate axis, meanwhile, determining that a mapping coordinate of the adjacent map traversal block in the same vertical coordinate axis direction on the horizontal coordinate axis is the same as the mapping coordinate of the currently determined map traversal block on the horizontal coordinate axis, and then returning to S33, so that mapping coordinates of each of the map traversal block in the same vertical coordinate axis direction are determined row by row under a constraint effect of a coverage number in the same vertical coordinate axis direction;
S35, adding the mapping coordinate of the currently determined map traversal block on the horizontal coordinate axis with the side length of the map traversal block to calculate and determine a mapping coordinate of the adjacent map traversal block in the same horizontal coordinate axis direction on the horizontal coordinate axis, meanwhile, determining that a mapping coordinate of the adjacent map traversal block in the same horizontal coordinate axis direction on the vertical coordinate axis is the same as the mapping coordinate of the currently determined map traversal block on the vertical coordinate axis, and then entering S36, so that mapping coordinates of each of the map traversal block in the same horizontal coordinate axis direction are determined column by column under a constraint effect of a coverage number in the same horizontal coordinate axis direction;
S36, judging whether a number of the map traversal blocks of which the mapping coordinates have been determined in the horizontal coordinate axis direction is smaller than the coverage number of the map traversal blocks in the horizontal coordinate axis direction of the global grid map or not, in a case that the number of the map traversal blocks of which the mapping coordinates have been determined in the horizontal coordinate axis direction is smaller than the coverage number of the map traversal blocks in the horizontal coordinate axis direction of the global grid map, returning to S33, otherwise, determining that the mapping coordinates of each of the map traversal block in the global grid map have been calculated row by row and column by column, so that the map traversal blocks are established in each row and each column of the global grid map, and a block processing of the global grid map is completed.

16. The chip according to claim 14, wherein S3 specifically comprises:
S31, taking the grid position at the lower left corner of the global grid map as a reference original point, and then entering S32;
S32, starting from the reference original point, adding a coordinate of the reference original point on the horizontal coordinate axis with the side length of the map traversal block to calculate and determine the mapping coordinate of the adjacent map traversal block in the same horizontal coordinate axis direction on the horizontal coordinate axis, meanwhile, determining that the mapping coordinate of the currently determined map traversal block on the vertical coordinate axis is equal to the coordinate of the reference original point on the vertical coordinate axis, and then entering S33, wherein the reference original point is the position with the minimum coordinate value on each of the global coordinate axis of the global grid map;
S33, judging whether the number of the map traversal blocks of which the mapping coordinates have been determined in the horizontal coordinate axis direction is smaller than the coverage number of the map traversal blocks in the horizontal coordinate axis direction of the global grid map or not, in a case that the number of the map traversal blocks of which the mapping coordinates have been determined in the horizontal coordinate axis direction is smaller than the coverage number of the map traversal blocks in the horizontal coordinate axis direction of the global grid map, entering S34, otherwise, entering S35;
S34, adding the mapping coordinate of the currently determined map traversal block on the horizontal coordinate axis with the side length of the map traversal block to calculate and determine the mapping coordinate of the adjacent map traversal block in the same horizontal coordinate axis direction on the horizontal coordinate axis, meanwhile, determining that the mapping coordinate of the adjacent map traversal block in the same horizontal coordinate axis direction on the vertical coordinate axis is the same as the mapping coordinate of the currently determined map traversal block on the vertical coordinate axis, and then entering S33, so that the mapping coordinates of each of the map traversal block in the same horizontal coordinate axis direction are determined column by column under the constraint effect of the coverage number in the same horizontal coordinate axis direction;
S35, adding the mapping coordinate of the currently determined map traversal block on the vertical coordinate axis with the side length of the map traversal block to calculate and determine the mapping coordinate of the adjacent map traversal block in the same vertical coordinate axis direction on the vertical coordinate axis, meanwhile, determining that the mapping coordinate of the adjacent map traversal block in the same vertical coordinate axis direction on the horizontal coordinate axis is the same as the mapping coordinate of the currently determined map traversal block on the horizontal coordinate axis, and then entering S36, so that the mapping coordinates of each of the map traversal block in the same vertical coordinate axis direction are determined row by row under the constraint effect of the coverage number in the same vertical coordinate axis direction;
S36, judging whether the number of the map traversal blocks of which the mapping coordinates have been determined in the vertical coordinate axis direction is smaller than the coverage number of the map traversal blocks in the vertical coordinate axis direction of the global grid map or not, in a case that the number of the map traversal blocks of which the mapping coordinates have been determined in the vertical coordinate axis direction is smaller than the coverage number of the map traversal blocks in the vertical coordinate axis direction of the global grid map, returning to S33, otherwise, determining that the mapping coordinates of each of the map traversal block in the global grid map have been calculated row by row and column by column, so that the map traversal blocks are established in each row and each column of the global grid map, and the block processing of the global grid map is completed.

17. The chip according to claim 15, wherein a coordinate of a grid point traversed by a robot on the vertical coordinate axis is greater than or equal to the mapping coordinate of the map traversal block on the vertical coordinate axis; the coordinate of the grid point traversed by the robot on the vertical coordinate axis is smaller than or equal to a result obtained by subtracting one from the sum of the mapping coordinate of the map traversal block on the vertical coordinate axis and the side length of the map traversal block; a coordinate of the grid point traversed by the robot on the horizontal coordinate axis is greater than or equal to the mapping coordinate of the map traversal block on the horizontal coordinate axis; the coordinate of the grid point traversed by the robot on the horizontal coordinate axis is smaller than or equal to a result obtained by subtracting one from the sum of the mapping coordinate of the map traversal block on the horizontal coordinate axis and the side length of the map traversal block, and it is determined that the grid point traversed by the robot is located in the map traversal block.

18. The chip according to claim 16, wherein a coordinate of a grid point traversed by a robot on the vertical coordinate axis is greater than or equal to the mapping coordinate of the map traversal block on the vertical coordinate axis; the coordinate of the grid point traversed by the robot on the vertical coordinate axis is smaller than or equal to a result obtained by subtracting one from the sum of the mapping coordinate of the map traversal block on the vertical coordinate axis and the side length of the map traversal block; a coordinate of the grid point traversed by the robot on the horizontal coordinate axis is greater than or equal to the mapping coordinate of the map traversal block on the horizontal coordinate axis; the coordinate of the grid point traversed by the robot on the horizontal coordinate axis is smaller than or equal to a result obtained by subtracting one from the sum of the mapping coordinate of the map traversal block on the horizontal coordinate axis and the side length of the map traversal block, and it is determined that the grid point traversed by the robot is located in the map traversal block.

19. The chip according to claim 17, wherein when a cleaning robot traverses any grid in the map traversal block, a corresponding map traversal block is marked as a traversed map traversal block.
